(19) United States
(12) Patent Application Publication
(10) Pub. No.: US 2008/0128462 A1
(43) Pub. Date: Jun. 5, 2008

(54) ARTICLE CARRIER WITH STOWABLE CROSS RAIL

(76) Inventors: John H. Harberts, Macomb, MI (US); Ronald G. Saward, Shelby Township, MI (US); John E. Klinkman, Riley Township, MI (US)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 11/944,005

(22) Filed: Nov. 21, 2007

Related U.S. Application Data
(60) Provisional application No. 60/860,739, filed on Nov. 22, 2006.

(51) Int. Cl. B60R 9/045; B60R 9/04

(52) U.S. Cl. 224/321; 224/309

(57) ABSTRACT

An article carrier assembly for a vehicle is provided, including a side rail and a cross rail. The side rail includes a top surface that defines, at least in part, a maximum height of the side rail. The cross rail is operable to be secured to the side rail in a stowed position and a deployed position. The cross rail is located generally below the maximum height of the side rail when the cross rail is in the stowed position, and the cross rail is above the maximum height of the side rail when the cross rail is in the deployed position.

### CROSS REFERENCE TO RELATED APPLICATIONS

This application claims priority to U.S. Provisional Patent Application 60/860,739, filed Nov. 22, 2006, which is incorporated by reference in its entirety.

### TECHNICAL FIELD

The present disclosure relates generally to an article carrier assembly and, more particularly, to an article carrier assembly including at least one cross rail that is secured to a side rail and selectively moveable between a stowed position and a deployed position.

### BACKGROUND

Article carrier assemblies are well known for use in storing or retaining luggage, bicycles, small boats, or the like on the exterior of a motor vehicle. Typically, two side rails that are provided generally parallel to one another and extend between the front and the rear of the vehicle. At least one cross rail is positioned between and selectively secured to the two side rails by way of a support.

In one type of article carrier assembly, each cross rail is positioned generally perpendicular to the side rails. Cross rails are typically used to secure accessories and cargo to the article carrier assembly. However, when the article carrier assembly is not in use, the cross rails provide several disadvantages. First, because the cross rails are typically positioned generally perpendicular in relation to the front and rear of the vehicle, the cross rails increase wind noise and decreases the fuel economy of the vehicle.

Moreover, some article carrier assemblies position the cross rails on top of the side rails. Because the cross rails are positioned on top of the vehicles, the cross rails also add extra height as well. Increased vehicle height is undesirable, especially when the vehicle is being shipped inside of a cargo carrier. Cargo carriers are typically used to ship multiple vehicles from the assembly plant to a dealer. Space inside the cargo carrier is very limited, and the extra height of the cross rails results in fewer vehicles being placed inside the carrier. In one approach, the article carrier assemblies are removed from the top of the vehicle before shipment, and then placed back on the vehicle after shipment. However, this approach results in extra labor and costs to ship the vehicle.

Thus, there exists a need for an article carrier assembly where the cross rail can be stowed when not in use in a position that does not increase the overall height of the vehicle.

### BRIEF DESCRIPTION OF THE DRAWINGS

FIG. 1 is an elevational perspective view of the top of a motor vehicle with an article carrier assembly in a deployed position, and includes a pair of side rails and a pair of cross rails;

FIG. 2 is an enlarged view of Region 2 in FIG. 1;

FIG. 3 is a partially cross sectional view of one of the side rails and one of the cross rails in a stowed position;

FIG. 4 is a partially exploded view of the cross rail, the side rail, a closure device and an adjustable mount when the article carrier assembly is in the deployed position;

FIG. 5 is an elevational perspective view of one of the cross rails;

FIG. 6 is an alternative exemplary illustration of the article carrier assembly, including one of the side rails; and

FIG. 7 is a process flow diagram of a method of deploying and stowing a cross rail of an article carrier assembly.

### DETAILED DESCRIPTION

Referring now to the discussion that follows and also to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

According to various exemplary illustrations described herein, an article carrier assembly is provided that includes at least one side rail and at least one cross rail. The side rail is configured to be installed to a surface of a vehicle, and includes a top surface that defines, at least in part, a maximum height. The cross rail is operable to be secured to the side rail and selectively moveable between a stowed position and a deployed position. The cross rail may be located generally below the maximum height of the side rail when the cross rail is in the stowed position, and in some exemplary approaches above the maximum height of the side rail when the cross rail is in the deployed position. An adjustable mount including a first closure loop for receiving the side rail and a second closure loop for receiving the cross rail may also be provided. When closure loops are used the cross rail may be received by the second closure loop when the cross rail is in the stowed position and may be secured to a top surface of the adjustable mount when in the deployed position.

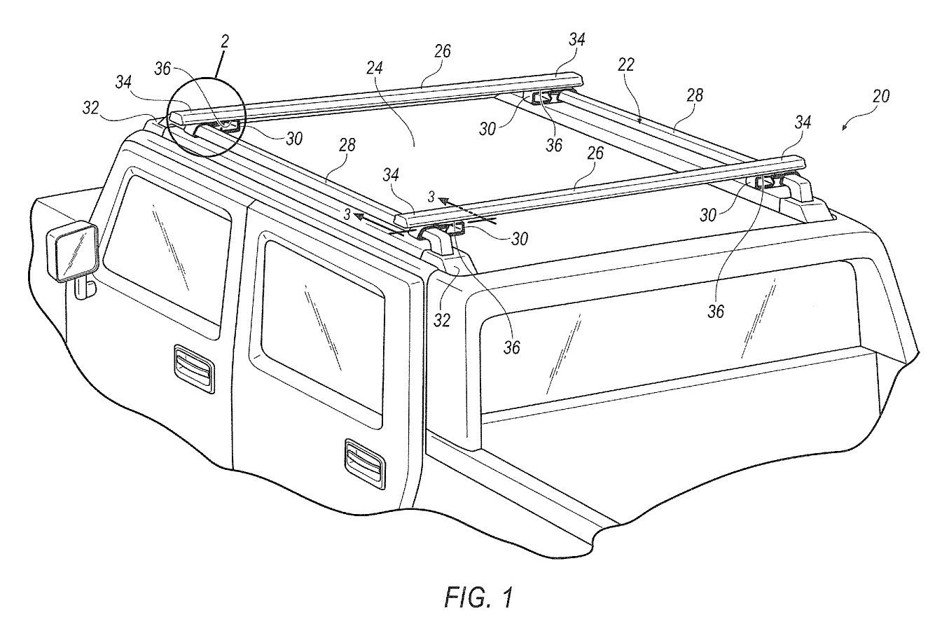

Turning now to the drawings and in particular to FIG. 1, a motor vehicle 20 is illustrated in FIG. 1 having an article carrier assembly 22 secured to a roof 24 of the vehicle 20. The article carrier assembly 22 includes a pair of side rails 28 extending generally from the front to the rear of the vehicle 20, each side rail 28 being disposed between two cross rails 26. The article carrier assembly 22 further includes adjustable mounts 30. In the illustration as shown, four of the adjustable mounts 30 are positioned on side rails 28, where two adjustable mounts 30 are illustrated on each of the ends of the side rails 28. The adjustable mounts 30 are employed to position and secure the cross rails 26 to the side rails 28. Although FIG. 1 illustrates the article carrier assembly 22 located and secured to the roof 24 of the vehicle 20, it should be noted that the article carrier assembly 22 may be located and secured to any substantially planar surface of the vehicle 20, such as, but not limited to, a bed of a pickup truck or a deck lid of a trunk.

The side rails 28 are configured to be installed to a surface of the vehicle 20 in a variety of ways that are known in the art. In one illustrative example, as seen in FIG. 1, the side rails 28 are attached to the roof 24 by a support structure 32. It should be noted that while FIG. 1 illustrates two cross rails 26, only one cross rail 26 or more than two cross rails 26 may be employed as well.

In the illustration as shown in FIG. 1, the article carrier assembly 22 is shown in a deployed position. When in the deployed position, each end portion 34 of the cross rails 26 is shown secured on a top surface 36 of one of the adjustable mounts 30. The adjustable mounts 30 provide stability of the cross rail 26 when stored in either the stowed or deployed position. Accessories or cargo (not shown) can be secured to the article carrier assembly 22 when in the deployed position. When not in use, the article carrier assembly 22 can be placed in a stowed position. More specifically, the cross rail 26 is operable to be secured to the side rail 28 in a stowed position as well as the deployed position, and is discussed in greater detail below.

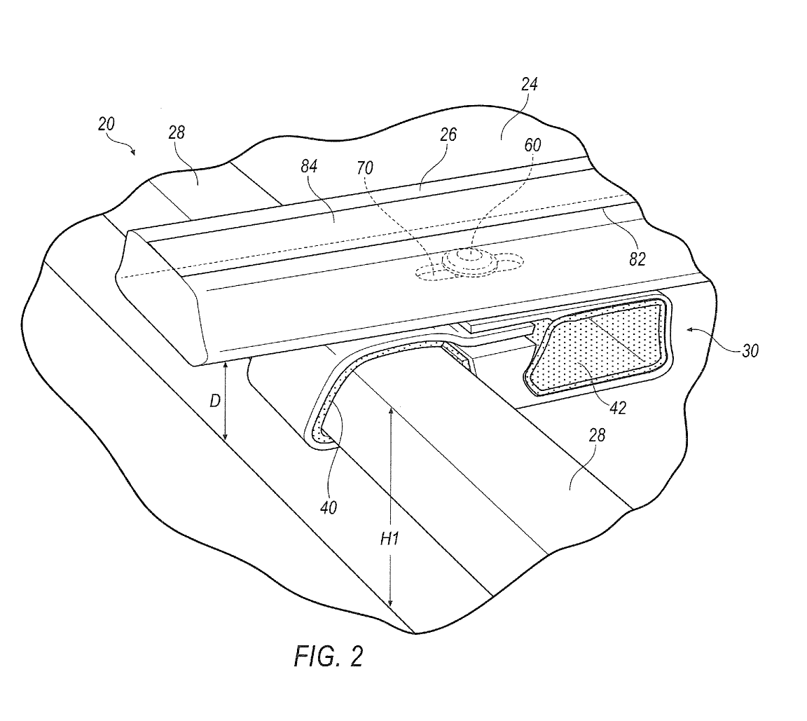

FIG. 2 is an enlarged view of one of the adjustable mounts 30. FIG. 2 illustrates the cross rail 26 in the deployed position. The adjustable mount 30 includes a first closure loop 40 and a second closure loop 42, where the first closure loop 40 receives the side rail 28 and the second closure loop 42 receives the cross rail 26. More specifically, the first closure loop 40 generally conforms and wraps around the side rail 28. The second closure loop 42 similarly conforms around the cross rail 26 when the article carrier assembly 22 is in the stowed position, and is discussed in greater detail below.

When the cross rail 26 is in the deployed position, the cross rail 26 may be above the side rail 28. More specifically, in an exemplary illustration a top surface 38 of the side rail 28 defines a maximum height H1 of the side rail 28. When the cross rail 26 is in the deployed position, the cross rail 26 is shown positioned above the maximum height H1 of the side rail 28 and is also shown generally perpendicular to the side rail 28. Moreover, in the illustration as shown in FIG. 2, the cross rail 26 is secured to the top surface 36 of the adjustable mount 30 when the cross rail 26 is placed in the deployed position. Positioning the cross rail 26 on top the side rail 28 is often desirable to increase the load-carrying capacity of the cross rail 26.

The cross rails 26 are placed generally perpendicular to the side rails 28 in the deployed position and are spaced at a predetermined distance D from the roof 24 of the vehicle 20. Spacing the cross rails 26 at the predetermined distance D will decrease the risk of accessories or cargo contacting the roof 24 of the vehicle 20. It is typically undesirable to have cargo contacting the surface of the roof 24, as such contact may cause damage. For example, if cargo secured to the article carrier assembly 22 contacts the surface of the roof 24, such contact may scratch the surface of the roof 24.

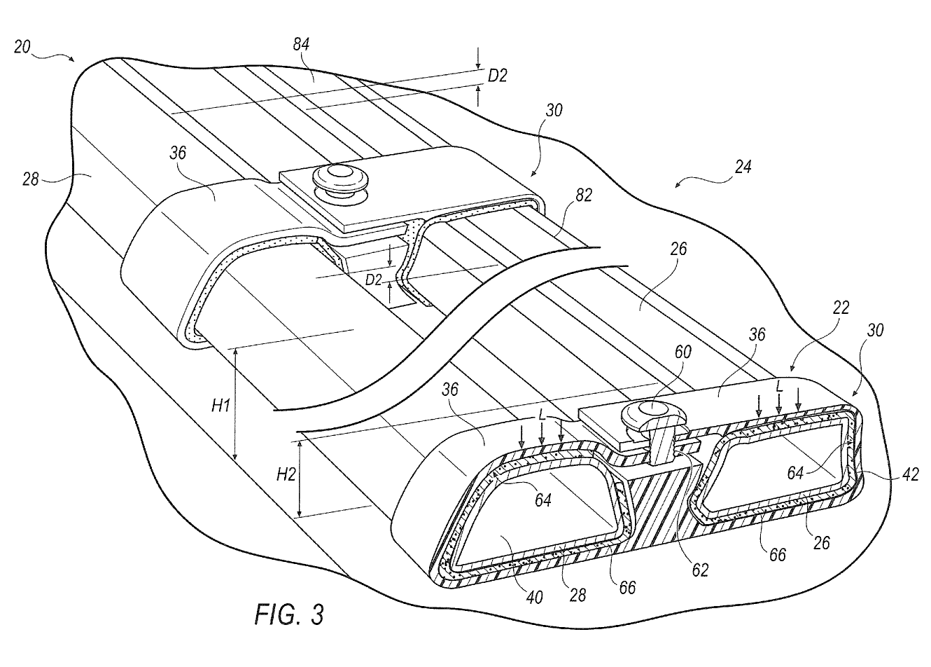

FIG. 3 is a partially sectional side view of the article carrier assembly 22 when in the stowed position. That is, one of the adjustable mounts 30 is shown partially sectioned along line 3-3 of FIG. 1. In the stowed position, the cross rail 26 may be positioned generally parallel to the side rail 28. The cross rail 26 may be positioned generally below the maximum height H1 of the side rail 28 when in the stowed position. That is, as seen in FIG. 3, the side rail 28 includes a height H2 that is generally below the maximum height H1 of the side rail 28. As shown, the difference between H1 and H2 is represented by the distance D2.

Because the cross rail 26 is shown located generally below the maximum height H1 of the side rail 28, the maximum height of the article carrier assembly 22 is defined by the height H1 when in the stowed position. This configuration provides a minimal overall height of the article carrier assembly 22 when the cross rail 26 is in the stowed position, which in turn provides several benefits. For example, the minimal overall height of the article carrier assembly 22 provides less wind noise and increased fuel economy when compared to the article carrier assembly 22 being in the deployed position. Placing the cross rail 26 generally parallel to a longitudinal axis defined between the front and rear of the vehicle 20 also reduces wind noise and increases fuel economy when compared to the deployed position as seen in FIGS. 1-2.

The overall height of the vehicle 20 is reduced when the cross rail 26 is in the stowed position, which may become advantageous when the vehicle 20 is shipped inside of a cargo carrier that has a very limited amount of space. Indeed, when the article carrier assembly 22 is not being utilized to secure accessories or cargo to the roof 24 of the vehicle 20, the article carrier assembly 22 may be placed in the stowed configuration, thus minimizing the overall height of the vehicle.

As seen in FIG. 3, the adjustable mount 30 includes a closure device 60, which in the exemplary illustration is a screwtype fastener. It should be noted that while FIG. 3 illustrates the closure device 60 as a screw-type fastener, any mechanism that secures the first closure loop 40 around the side rail 28 and the second closure loop 42 around the cross rail 26 may be used. For example, the closure device 60 may be a locking pin. Alternatively, the closure device 60 may be omitted, and the first closure loop 40 and the second closure loop 42 may be secured in place by a series of alternative locking mechanism integrated directly into the closure loops such as an integrated hook at a free end received within a corresponding loop or even in some situations potentially fabric hook-and-loop fasteners such as Velcro®.

The grip of the first closure loop 40 around the side rail 28 and the grip of the second closure loop 42 around the cross rail 26 is tightened by the closure device 60. More specifically, the closure device 60 engages both of the first closure loop 40 and the second closure loop 42 by way of a threaded screw hole 62 that receives the illustrated screw-type fastener. In the illustrated example when tightened using a screw mechanism, closure device 60 selectively applies a downward load L that is exerted to both the cross rail 26 as well as the side rail 28. The downward load L further tightens the grip of the first closure loop 40 and the second closure loop 42.

The grip of the first closure loop 40 and the second closure loop 42 may be further enhanced by a pad 66 that lines an inner surface 64 of the first closure loop 40 and the second closure loop 42. The pad 66 is typically constructed from a high-friction material, such as, but not limited to, a foam or a polymer. In one example, the adjustable mount 30 is constructed from a flexible plastic or a rubber.

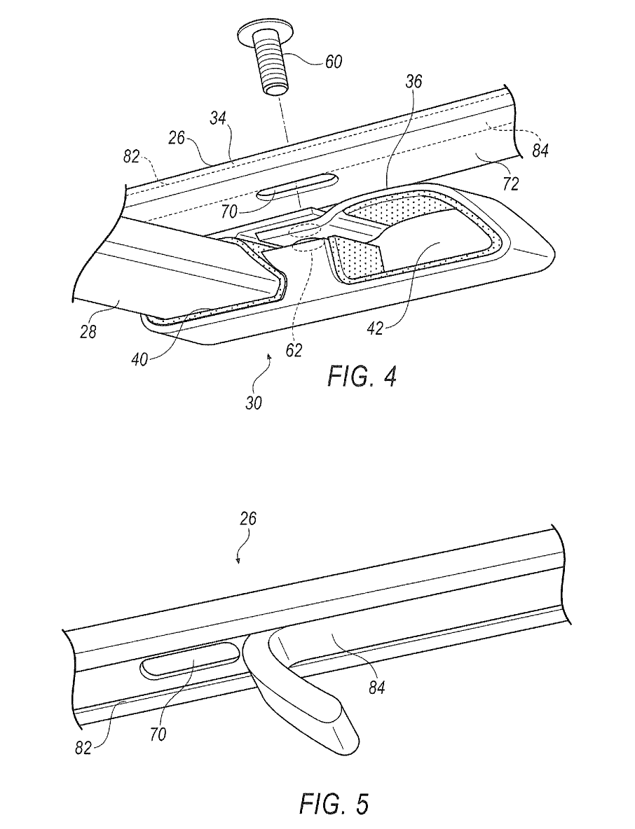

The second closure loop 42 of the adjustable mount 30 may be loosened or opened by loosening or removing the closure device 60. The cross rail 26 may then be removed from the second closure loop 42, and placed on top of the adjustable mount 30, along the top surface 36. More specifically, as best seen in FIG. 4, the cross rail 26 includes an aperture such as a hole or a slot, that is a mounting hole 70 provided along a bottom surface 72 of the cross rail 26.

The closure device 60 may be threaded through the mounting hole 70 and also tightened to the screw hole 62 located in the adjustable mount 30. This secures the cross rail 26 to the adjustable mount 30 when the cross rail 26 is in the deployed position. It should be noted that FIG. 4 is only one exemplary illustration of how the cross rail 26 may be secured to the adjustable mount 30 in the deployed position, and devices other than the closure device 60 and the mounting hole 70 may be used as well. In one example, the cross rail 26 may include a feature, such as an outwardly extending tab, located along the bottom surface 72 that is received and in engagement with the hole 62 of the adjustable mount 30. It should also be noted that while FIG. 4 illustrates the closure device 60 being utilized for both the stowed and the deployed positions, separate securing mechanisms can be used for each of the stowed and the deployed positions as well.

When a user desires to move the cross rail 26 from the deployed position as seen in FIGS. 1-2 to the stowed position as seen in FIG. 3, a user will first loosen and potentially remove the closure device 60 from the screw hole 62 of the adjustable mount 30 and from the mounting hole 70 of the cross rail 26. The closure device 60 is accessed though a removable insert 84 that covers an attachment slot 82 of the cross rail 26, and is explained in greater detail below. Removing the closure device 60 from the cross rail 26 and the adjustable mount 30 will allow for the cross rail 26 to be removed from the top surface 36 of the adjustable mount 30. Once the cross rail 26 is removed, a user may then place the cross rail 26 within the second closure loop 42 of the adjustable mount 30, as seen in FIG. 3. Once positioned within the second closure loop 42, the cross rail 26 is now in the stowed position.

A user may also remove the cross rail 26 from the second closure loop 42 when the cross rail 26 is in the stowed position and place the cross rail 26 in the deployed position as well. As discussed above, the second closure loop 42 of the adjustable mount 30 may be loosened or opened by loosening or removing the closure device 60. The cross rail 26 is then removed from the second closure loop 42, and secured to the top surface 36 of the adjustable mount 30 in the deployed position.

In some situations when the article carrier assembly 22 is not in use, a user may desire to completely remove the cross rail 26 from the article carrier assembly 22. A user may also remove the adjustable mount 30 from the side rail 28 as well. Removing the cross rail 26 and the adjustable mount 30 from the article carrier assembly 22 is advantageous, because the absence of the cross rail 26 and the adjustable mount 30 will result in reduced wind noise, increased fuel economy, and a decrease in overall vehicle height when the article carrier assembly 22 is not in use, as discussed above.

The cross rail 26 may include at least one feature which facilitates the attachment of accessories or cargo. FIG. 5 illustrates the cross rail 26 with the accessory attachment slot 82 that extends along the cross rail 28. The attachment slot 82 may extend along the entire length of the cross rail 26, or the attachment slot 82 may only extend along a portion of the rail as well.

The accessory attachment slot 82 allows for accessories to be secured to the cross rail 26 by positive engagement with the attachment slot 82. The cross rail 26 may also includes the insert 84 that covers the attachment slot 82 when not in use. In one illustration, the insert is constructed from a flexible material, such as rubber. It should be noted that while FIG. 5 illustrates the attachment slot 82, other features, such as, but not limited to, holes, slots or tabs may also be provided along the cross rail for securing accessories as well.

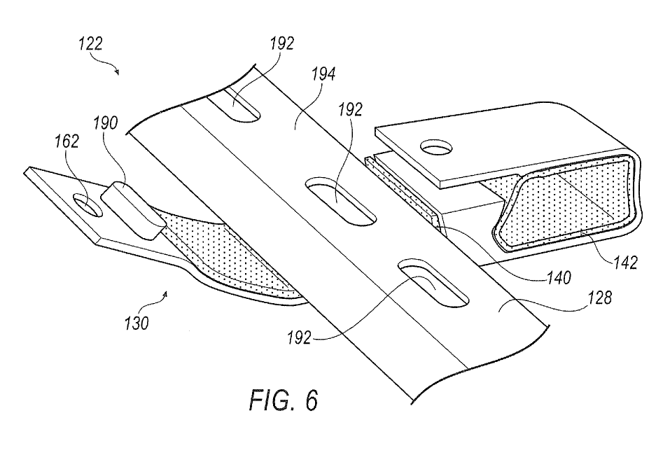

In one alternative illustration, the side rail 128 can be secured to the adjustable mount 30 at several defined positions along the side rail 128. For example, in the alternative illustration of FIG. 6, the adjustable mount 130 includes a tab 190 that is in engagement with one of the mounting holes 192 that are located along an upper surface 194 of the side rail 128. The mounting holes 192 are positioned at predetermined locations along the upper surface 194 of the side rail 128.

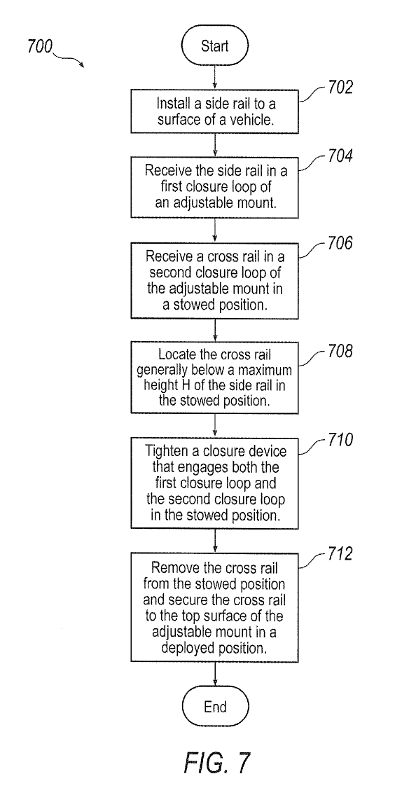

Turning now to FIG. 7, a process 700 for deploying and stowing the cross rail of the article carrier assembly is illustrated. Process 700 may begin at step 702, where a side rail 28 is installed to a surface of a vehicle. For example, as discussed above, the side rail 28 is installed to the vehicle 20 at the roof 24. The side rail 28 includes the top surface 36 that defines, at least in part, a maximum height H1. However, in some alternative approaches step 702 is omitted in its entirety of carried out at a later time. For example, it is possible for side rail 28 and cross rail 26 to be shipped as an assembly in a stowed position without mounting the side rail to a vehicle. The cross rail 26 would not impede the ability to carry out step 702 at a later time such as at an assembly plant when the stowed assembly is then mounted by way of side rail 28 as discussed with respect to step 702. An advantage of such an approach is that there are fewer parts to manipulate as part of the assembly process and the cross rails 26 do not impede assembly. Typically, when installing a side rail 28, fasteners extend through an opening in the side rail and into a corresponding vehicle component. Process 700 may then proceed to step 704.

In step 704, the side rail is received in a first closure loop of an adjustable mount. For example, as discussed above, the first closure loop 40 of the adjustable mount 30 receives the side rail 28. More specifically, the first closure loop 40 generally conforms and wraps around the side rail 28. Process 704 may then proceed to step 706.

In step 706, a cross rail is received in a second closure loop of the adjustable mount when the cross rail is in a stowed position. For example, as discussed above, the second closure loop 42 receives the cross rail 26. Process 706 may then proceed to step 708.

In step 708, the cross rail is located generally below the maximum height of the side rail in the stowed position. For example, as discussed above, the cross rail 26 is located generally below the maximum height H1 of the side rail 28. Process 708 may then proceed to step 710.

In step 710, a closure device that engages both of the first closure loop and the second closure loop is tightened. For example, as discussed above, the closure device 60 applies the downward load L that further tightens the grip of the first closure loop 40 and the second closure loop 42. Process 708 may then proceed to step 710.

In step 712, the cross rail is removed from the stowed position and placed in the deployed position by securing the cross rail to the top surface of the adjustable mount by an aperture in the cross rail. For example, as discussed above, a user may remove the cross rail 26 from the second closure loop 42 when the cross rail 26 is in the stowed position. The second closure loop 42 of the adjustable mount 30 may be loosened or opened by loosening or removing the closure device 60. The cross rail 26 is then removed from the second closure loop 42. The cross rail 26 includes an aperture such as the mounting hole 70 provided along the bottom surface 72 of the cross rail 26. The closure device 60 may be threaded through the mounting hole 70 and also tightened to the screw hole 62 located in the adjustable mount 30. This secures the cross rail 26 to the adjustable mount 30 when the cross rail 26 is in the deployed position. Process 700 may then terminate.

While the present disclosure has been particularly shown and described with reference to the foregoing preferred illustrations, it should be understood by those skilled in the art that various alternatives to the illustrations of the disclosure described herein may be employed in practicing the disclosure without departing from the spirit and scope of the disclosure as defined in the following claims. It is intended that the following claims define the scope of the disclosure illustrations within the scope of these claims and their equivalents be covered thereby. This description of the disclosure should be understood to include all novel and non-obvious combinations of elements described herein, and claims may be presented in this or a later application to any novel and non-obvious combination of these elements. The foregoing embodiment is illustrative, and no single feature or element is essential to all possible combinations that may be claimed in this or a later application.

What is claimed is:

1. A article carrier assembly for a vehicle, comprising:
a side rail including a top surface that defines, at least in part, a maximum height of the side rail; and
at least one cross rail operable to be secured to the side rail in a stowed position and a deployed position;
wherein the cross rail is located generally below the maximum height of the side rail when the cross rail is in the stowed position, and the cross rail is above the maximum height of the side rail when the cross rail is in the deployed position.

2. The article carrier assembly as recited in claim 1, further comprising an adjustable mount including a first closure loop for receiving the side rail and a second closure loop for receiving the cross rail.

3. The article carrier assembly as recited in claim 2, further comprising a closure device that engages both of the first closure loop and the second closure loop and tightens the first closure loop and the second closure loop.

4. The article carrier assembly as recited in claim 3, wherein the cross rail includes an aperture, the closure device being received by the aperture to secure the cross rail to the adjustable mount in the deployed position.

5. The article carrier assembly as recited in claim 2, wherein the cross rail is received by the second closure loop when the cross rail is in the stowed position.

6. The article carrier assembly as recited in claim 2, wherein the cross rail is in the deployed position when the cross rail is secured to a top surface of the adjustable mount.

7. The article carrier assembly as recited in claim 1, wherein the cross rail is in the stowed position when the cross rail is positioned generally parallel with the side rail.

8. The article carrier assembly as recited in claim 1, wherein the cross rail is in the deployed position when the cross rail is positioned generally perpendicular to the side rail.

9. The article carrier assembly as recited in claim 1, wherein the cross rail includes an accessory attachment slot extending along at least a portion of the cross rail.

10. A article carrier assembly for a vehicle, comprising:
a side rail including a top surface that defines, at least in part, a maximum height;
at least one cross rail operable to be secured to the side rail in a stowed position and a deployed position; and
an adjustable mount including a first closure loop for receiving the side rail, a second closure loop for receiving the cross rail, and a top surface;
wherein the cross rail is located generally below the maximum height of the side rail and is received by the second closure loop when the cross rail is in the stowed position;
wherein the cross rail is above the maximum height of the side rail the cross rail and is secured to the top surface of the adjustable mount when the cross rail is in the deployed position.

11. The article carrier assembly as recited in claim 10, further comprising a closure device that engages both of the first closure loop and the second closure loop and tightens the first closure loop and the second closure loop.

12. The article carrier assembly as recited in claim 11, wherein the cross rail includes an aperture, the closure device being received by the aperture to secure the cross rail to the adjustable mount in the deployed position.

13. The article carrier assembly as recited in claim 10, wherein the cross rail includes an accessory attachment slot extending along at least a portion of the cross rail.

14. The article carrier assembly as recited in claim 10, wherein the cross rail is in the deployed position when the cross rail is positioned generally perpendicular to the side rail.

15. The article carrier assembly as recited in claim 10, wherein the cross rail is in the stowed position when the cross rail is positioned generally parallel with the side rail.

16. A method of deploying and stowing a cross rail of an article carrier assembly for a vehicle, comprising:
locating an adjustable mount along a portion of a side rail, the side rail including a top surface that defines, at least in part, a maximum height of the side rail;
receiving the side rail in a first closure loop of the adjustable mount;
receiving a cross rail in a second closure loop of the adjustable mount when the cross rail is in a stowed position, the cross rail being below the maximum height of the side rail when in the stowed position; and
removing the cross rail from the second closure loop and locating the cross rail generally above the maximum height of the side rail in a deployed position.

17. The method as recited in claim 16, further comprising the step of tightening a closure device that engages both of the first closure loop and the second closure loop and tightens the first closure loop and the second closure loop when the cross rail is in the stowed position.

18. The method as recited in claim 16, further comprising the step of securing the cross rail to a top surface of the adjustable mount by an aperture in the cross rail when in the deployed position, the closure device being received by the aperture.
